(19) United States
(12) Patent Application Publication
(10) Pub. No.: US 2010/0156861 A1
(43) Pub. Date: Jun. 24, 2010

(54) DISPLAY DRIVER AND DISPLAY APPARATUS

(76) Inventors: Tomohisa Sakaguchi, Kyoto (JP); Daijiro Arisawa, Kyoto (JP); Hiroshi Ando, Osaka (JP); Tetsu Nagano, Osaka (JP)

Correspondence Address: MCDERMOTT WILL & EMERY LLP, 600 13TH STREET, NW, WASHINGTON, DC, 20005-3096, US

(21) Appl. No.: 12/630,383

(22) Filed: Dec. 3, 2009

(30) Foreign Application Priority Data
Dec. 19, 2008 (JP) 2008-323781

(51) Int. Cl. G09G 5/00

(52) U.S. Cl. 345/205; 345/211

(57) ABSTRACT

A display driver includes a shift register; an OR circuit configured to perform an OR operation on data signals respectively representing bits in the shift register which are not adjacent to each other, and to output a result of the OR operation; a delay circuit configured to delay the output of the OR circuit, and to output the delayed output; timing generators respectively corresponding to the data signals, where each of the timing generators generates and outputs a first control signal including a first pulse and a second control signal including a second pulse in accordance with a corresponding one of the data signals and the output of the delay circuit; and output circuits respectively corresponding to the timing generators, where each of the output circuits outputs voltages of a first and a second power supply. A duration of the second pulse includes a duration of the first pulse.

### CROSS-REFERENCE TO RELATED APPLICATION

This application claims priority to Japanese Patent Application No. JP2008-323781 filed on Dec. 19, 2008, the disclosure of which including the specification, the drawings, and the claims is hereby incorporated by reference in its entirety.

### BACKGROUND

The present disclosure relates to display drivers for driving display panels and the like such as plasma display panels and liquid crystal display panels.

Display panels, in which a plurality of scan lines and a plurality of signal lines are arranged to cross each other, are well known. As such display panels, Flat Panel Displays (FPDs) such as Plasma Display Panels (PDPs), Liquid Crystal Displays (LCDs), and Electroluminescence (EL) panels are well known.

Japanese Published Patent Application 2001-154632 describes example signals used for driving scan lines. A driver for driving a display panel needs to generate an output signal for driving each scan line. As an output circuit for generating the output signal, a circuit with two switching elements coupled in series between a power supply and ground is generally used. If there is a period in which the two switching elements are simultaneously ON, a through current flows from the power supply to ground to cause an increase in power consumption. Thus, the through current needs to be prevented. Japanese Published Patent Applications H11-143427 and 2005-70335 show example output circuits which prevent through currents.

In order to prevent a through current in an output circuit and the like, control signals need to be generated with the use of delay circuits. In the circuits of Japanese Published Patent Applications H11-143427 and 2005-70335, a delay circuit is used for each output circuit. Since the area of each delay circuit is relatively large, a driver for a display panel generating numerous output signals requires a large overall circuit area. With a recent increase in pixel numbers of a display panel, the number of output signals of the driver has increased. This leads to a significant increase in the overall cost of the driver due to delay circuits.

### SUMMARY

It is an object of the present invention to reduce the circuit area of a display driver for driving a display panel, while preventing a through current.

A display driver according to one embodiment of the present invention includes a shift register configured to store bits represented by an input signal, and to serially shift the bits; an OR circuit configured to perform an OR operation on a plurality of data signals respectively representing the bits in the shift register which are not adjacent to each other, and to output a result of the OR operation; a delay circuit configured to delay the output of the OR circuit, and to output the delayed output; a plurality of timing generators respectively corresponding to the data signals, where each of the timing generators generates and outputs a first control signal including a first pulse and a second control signal including a second pulse in accordance with a corresponding one of the data signals and the output of the delay circuit; and a plurality of output circuits respectively corresponding to the timing generators, where each of the output circuits outputs a voltage of a first power supply in accordance with the first control signal of a corresponding one of the timing generators, and a voltage of a second power supply in accordance with the second control signal of the corresponding timing generator. A duration of the second pulse includes a duration of the first pulse.

In this configuration, the display driver includes a delay circuit for a plurality of data signals, thereby reducing the number of the delay circuits to less than the number of output signals. This enables reduction in the circuit area of the display driver while preventing a through current.

A display apparatus according to one embodiment of the present invention includes a display panel, and a display driver configured to generate a plurality of output signals to drive the display panel. The display driver includes a shift register configured to store bits represented by an input signal, and to serially shift the bits; an OR circuit configured to perform an OR operation on a plurality of data signals respectively representing the bits in the shift register which are not adjacent to each other, and to output a result of the OR operation; a delay circuit configured to delay the output of the OR circuit, and to output the delayed output; a plurality of timing generators respectively corresponding to the data signals, where each of the timing generators generates and outputs a first control signal including a first pulse and a second control signal including a second pulse in accordance with a corresponding one of the data signals and the output of the delay circuit; and a plurality of output circuits respectively corresponding to the timing generators, where each of the output circuits outputs a voltage of a first power supply in accordance with the first control signal of a corresponding one of the timing generators, and outputs a voltage of a second power supply in accordance with the second control signal of the corresponding timing generator, as a corresponding one of the output signals. A duration of the second pulse includes a duration of the first pulse.

According to the embodiments, the number of the delay circuits can be reduced to less than the number of the output signals. This can reduce the circuit area of the display driver while preventing a through current. Since the number of the delay circuits is small, variations in the generated delays can be reduced such that variations in the timing of the output signals can also be reduced.

### BRIEF DESCRIPTION OF THE DRAWINGS

FIG. 1 is a block diagram illustrating the configuration of a display apparatus according to one embodiment of the present invention.

FIG. 2 is a block diagram illustrating an example configuration of the scan driver shown in FIG. 1.

FIG. 3 is a timing diagram illustrating example signals in the scan driver shown in FIG. 2.

FIG. 4 is a block diagram illustrating the configuration of a modification of the scan driver shown in FIG. 2.

FIG. 5 is a timing diagram illustrating example signals in the scan driver shown in FIG. 4.

FIG. 6 is a block diagram illustrating the configuration of another modification of the scan driver shown in FIG. 2.

FIG. 7 is a circuit diagram illustrating an example configuration of an output section shown in FIG. 6.

### DETAILED DESCRIPTION

Hereinafter, embodiments of the present invention are described with reference to the drawings. In the drawings, the elements, which are indicated by reference numerals having the same last two digits, correspond to each other, and are the same or similar elements. The solid lines between functional blocks in the drawings represent electrical connections.

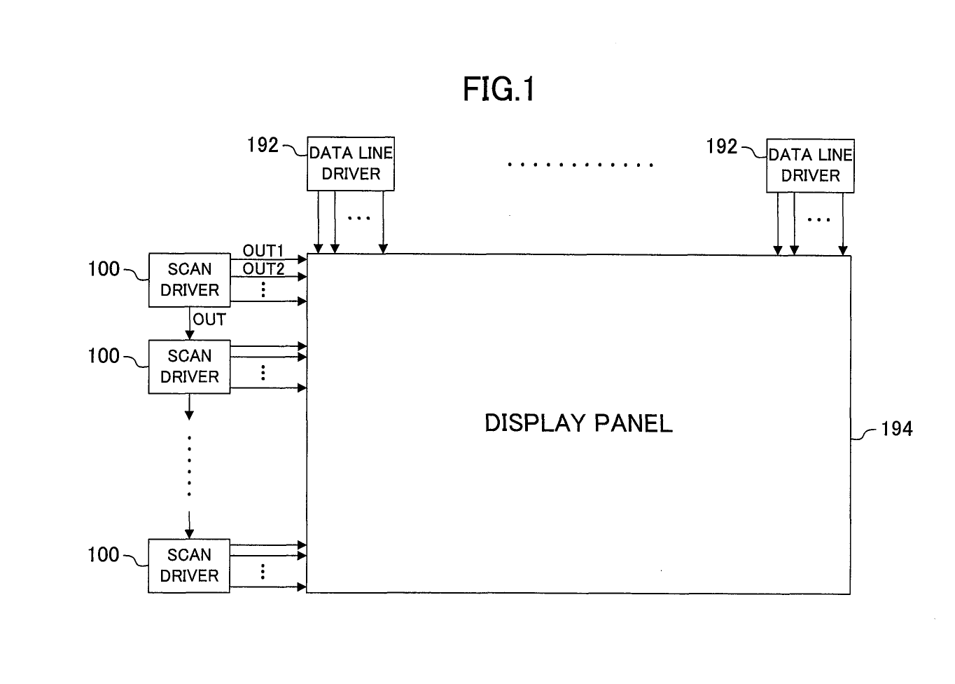

FIG. 1 is a block diagram illustrating the configuration of a display apparatus according to one embodiment of the present invention. The display apparatus of FIG. 1 includes a plurality of scan drivers 100, each of which serves as a display driver, a plurality of data line drivers 192, and a display panel 194 driven by the drivers. The display panel 194 is typically a plasma display panel, but may be other types of flat panel displays such as a liquid crystal display panel, an electroluminescence panel, and the like.

Each of the scan drivers 100 generates output signals OUT1, OUT2, . . . for driving the display panel 194, and drives a plurality of scan lines extending in a horizontal direction in FIG. 1 using the output signals OUT1, OUT2, . . . . Each of the data line drivers 192 drives a plurality of data lines extending in a vertical direction in FIG. 1 using a plurality of output signals. The scan driver 100 outputs pulses as the output signals OUT1, OUT2, . . . sequentially one by one, while delaying the timing; and notifies a next scan driver 100 using a signal OUT that the pulse of the last output signal has been output. This next scan driver 100 operates similarly and provides notice to another next scan driver 100.

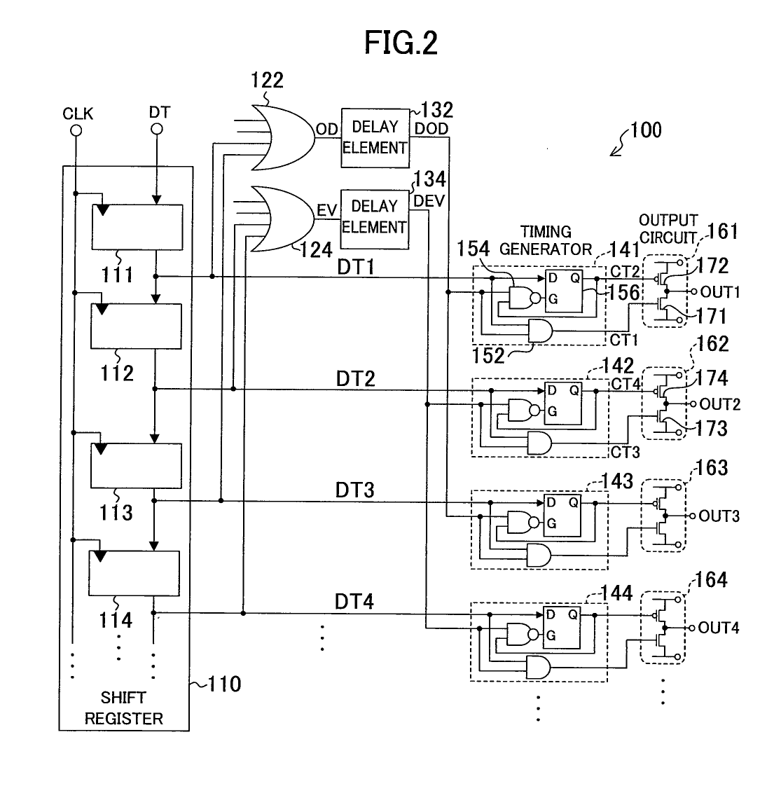

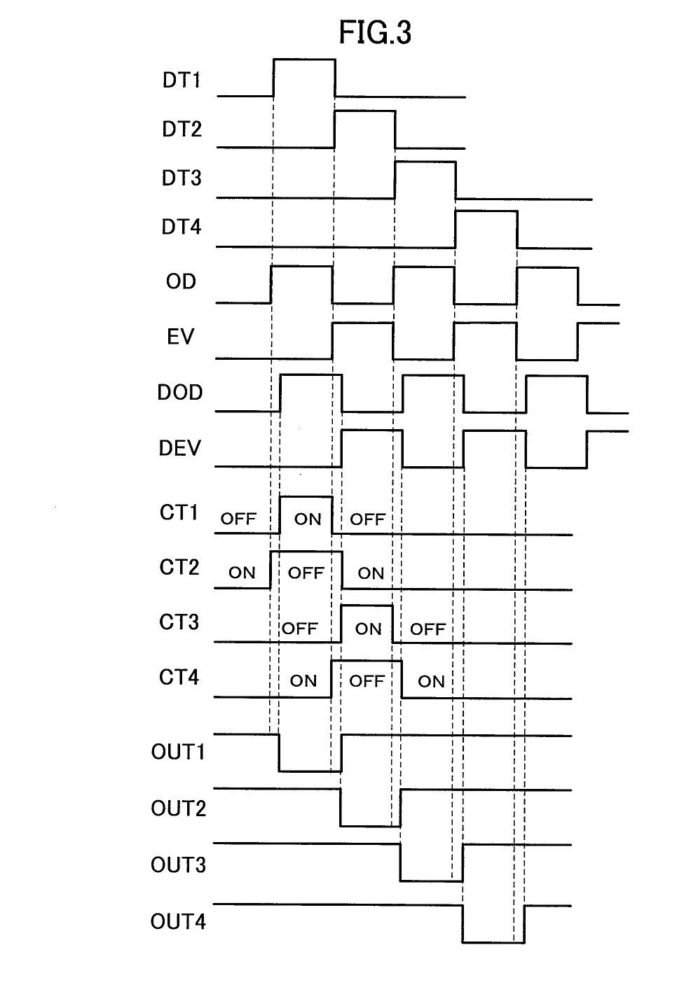

FIG. 2 is a block diagram illustrating an example configuration of the scan driver 100 shown in FIG. 1. The scan driver 100 includes a shift register 110, OR gates (OR circuits) 122 and 124, delay elements 132 and 134 as delay circuits, timing generators 141, 142, 143, 144, . . . , and output circuits 161, 162, 163, 164, . . . . More complex circuits may be used as the delay circuits. FIG. 3 is a timing diagram illustrating example signals in the scan driver 100 shown in FIG. 2.

The shift register 110 includes flip-flops 111, 112, 113, 114, . . . coupled in series, each of which can store a bit. The flip-flop 111 stores a bit represented by an input signal DT in synchronization with a clock CLK. The shift register 110 serially shifts each of the bits stored in the flip-flops 111-114 to the corresponding adjacent bit (i.e., the corresponding adjacent flip-flop) in synchronization with the clock CLK. The flip-flops 111, 112, 113, 114, . . . respectively output data signals DT1, DT2, DT3, DT4, . . . representing the stored bits to the timing generators 141, 142, 143, 144, . . . . For example, a pulse is input as an input signal DT. The pulse is output as the data signals DT1-DT4 on each pulse of the clock CLK as shown in FIG. 3.

Each of the OR gates 122 and 124 corresponds to ones of the data signals DT1-DT4, . . . , which respectively represent a plurality of bits not adjacent to each other in the shift register 110, so as not to share the same data signal between the OR gates 122 and 124. In this embodiment, since the number of the OR gates 122 and 124, and the number of the delay elements 132 and 134 are both two, each of the OR gates 122 and 124 corresponds to one out of every two of the data signals DT1-DT4, . . . . To be specific, the OR gate 122 corresponds to the data signals DT1, DT3, . . . , and the OR gate 124 corresponds to the data signals DT2, DT4, . . . . The OR gate 122 performs an OR operation on the data signals DT1, DT3, . . . and outputs a result of the OR operation to the delay element 132 as a signal OD. The OR gate 124 performs an OR operation on the data signals DT2, DT4, . . . , and outputs a result of the OR operation to the delay element 134 as a signal EV.

The delay element 132 delays the signal OD and outputs the delayed signal to the timing generators 141, 143, . . . as a signal DOD. The delay element 134 delays the signal EV and outputs the delayed signal to the timing generators 142, 144, . . . as a signal DEV. The waveforms of the signals OD, EV, DOD and DEV are as shown in FIG. 3.

The timing generators 141, 142, 143, 144, . . . correspond to the data signals DT1, DT2, DT3, DT4, . . . , respectively. The output circuits 161, 162, 163, 164, . . . correspond to the timing generators 141, 142, 143, 144, . . . , respectively. The timing generator 141 generates a control signal CT1 including pulses and a control signal CT2 including pulses, and outputs the generated signals to the output circuit 161 in accordance with the corresponding data signal DT1 and the output of the delay element 132 corresponding to the data signal DT1.

The timing generator 141 specifically includes an AND gate 152, a NAND gate 154, and a latch 156. The AND gate 152 performs an AND operation on the signal DT1 and the signal DOD, and outputs a result of the AND operation to the output circuit 161 as the control signal CT1. The NAND gate 154 generates and outputs the inverted value of a result of an AND operation on the signal DOD and the control signal CT2. The latch 156 outputs a value at an input terminal D as it is as the control signal CT2, when an input terminal G is logic high; and holds the value of the control signal CT2, when the input terminal G is logic low.

As shown in FIG. 3, the control signal CT1 is a signal having a rising edge delayed from the rising edge of the data signal DT1. The control signal CT2 rises in accordance with the signal DT1, and falls in accordance with the fall of the signal DOD. That is, a duration of a pulse of the control signal CT2 includes a duration of a pulse of the control signal CT1.

The timing generator 142 generates a control signal CT3 including pulses and a control signal CT4 including pulses, and outputs the generated signals to the output circuit 162 in accordance with the corresponding data signal DT2 and the output of the delay element 134 corresponding to the data signal DT2. Each of the timing generators 143, 144, . . . similarly generates two control signals, and outputs the generated signals to the corresponding output circuits 163, 164, . . . .

The output circuit 161 includes an NMOS (n-channel metal oxide semiconductor) transistor 171 and a PMOS (p-channel metal oxide semiconductor) transistor 172 as switching elements. The NMOS transistor 171 is coupled between a power supply for supplying a reference voltage, and an output node for outputting an output signal OUT1. The PMOS transistor 172 is coupled between a power supply for supplying a power supply voltage, and the output node.

The reference voltage is, for example, a floating ground voltage FGND. The voltage at the power supply, which is coupled to the PMOS transistor 172, is a voltage required to be supplied to a display panel to be driven. When the display panel is a plasma display panel, the voltage is, for example, a voltage VDDH which is 150 V higher than the reference voltage. The output circuit 161 outputs the reference voltage as a logic low level signal of the output signal OUT1 in accordance with the control signal CT1, and outputs the power supply voltage (e.g., the voltage VDDH) as a logic high level signal of the output signal OUT1 in accordance with the control signal CT2.

The operation of the output circuit 161 is described below. When the control signals CT1 and CT2 are both logic low; the NMOS transistor 171 is OFF, the PMOS transistor 172 is ON, and the output signal OUT1 is logic high. When the control signal CT2 goes to logic high, the PMOS transistor 172 is turned OFF.

Next, when the control signal CT1 goes to logic high, the NMOS transistor 171 is turned ON and the output signal OUT1 goes to logic low. Then, when the control signal CT1 goes to logic low, the NMOS transistor 171 is turned OFF. When the control signal CT2 goes to logic low, the PMOS transistor 172 is turned ON and the output signal OUT1 goes to logic high. Accordingly, a negative pulse is output as the output signal OUT1 as shown in FIG. 3.

Since the NMOS transistor 171 and the PMOS transistor 172 are not simultaneously ON, a through current at the output circuit 161 can be prevented. The other output circuits 162-164, . . . operate similarly, and pulses delayed one from the other by one cycle of the clock CLK are output as the output signals OUT2-OUT4, . . . .

According to the scan driver 100 shown in FIG. 2, since a delay element 132 for delaying odd-numbered data signals and a delay element 134 for delaying even-numbered data signals are included, there is no need to include a delay element for each of the data signals. Thus, particularly in a scan driver which generates numerous output signals, the number of delay elements occupying relatively large areas in a circuit can significantly decrease, thereby reducing the overall circuit area. This enables reduction in the overall cost of the scan driver. Furthermore, since the number of the delay elements is small, variations in the amounts of the delays can be reduced and the quality of the output signals can be improved.

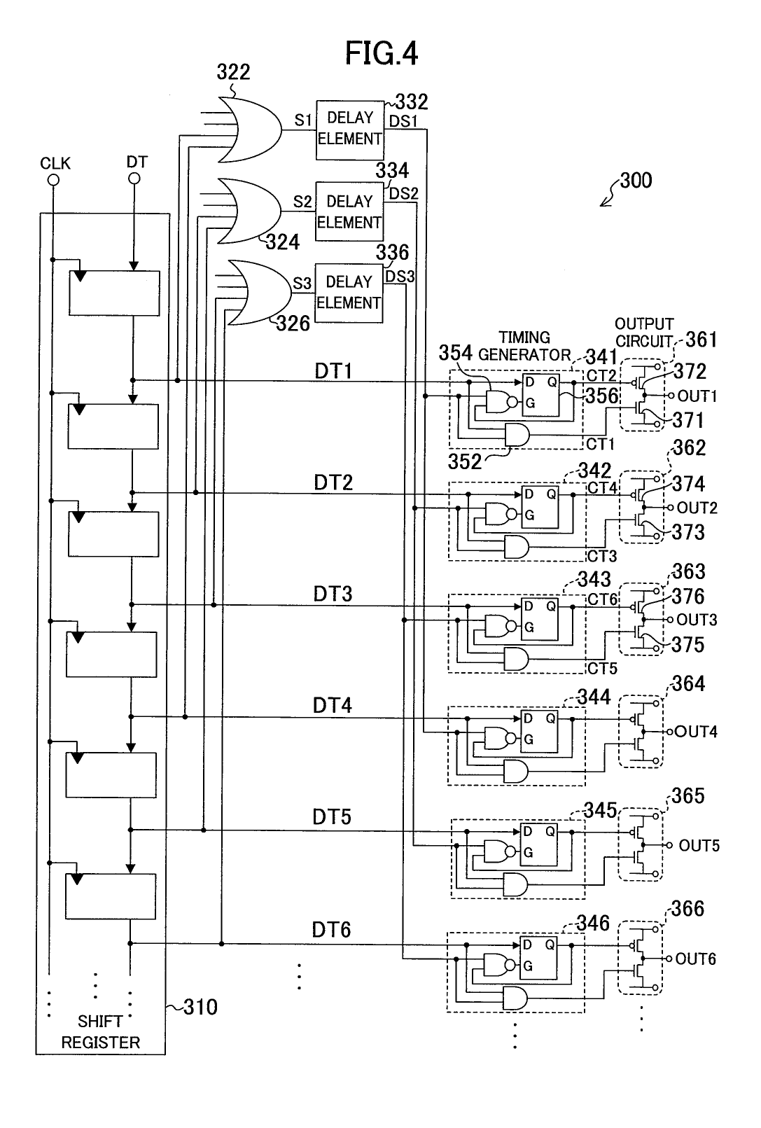

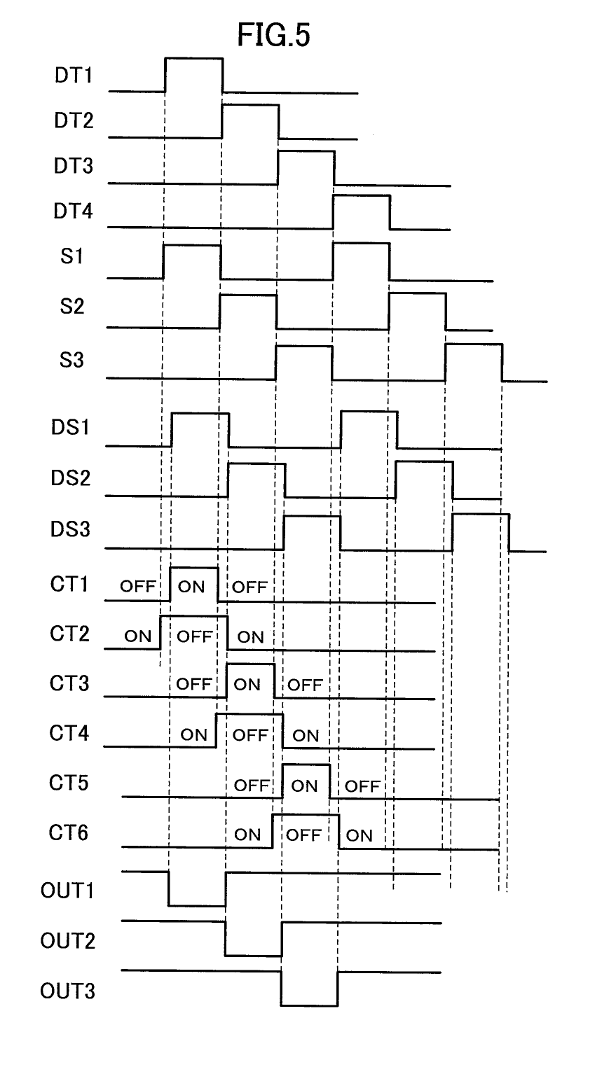

FIG. 4 is a block diagram illustrating the configuration of a modification of the scan driver shown in FIG. 2. The scan driver 300 shown in FIG. 4 includes three OR gates 322, 324 and 326, and three delay elements 332, 334 and 336. Otherwise, the scan driver 300 has almost the same configuration as the scan driver 100 shown in FIG. 2. The shift register 310 outputs data signals DT1, DT2, DT3, DT4, DT5, DT6, . . . . FIG. 5 is a timing diagram illustrating example signals in the scan driver 300 shown in FIG. 4.

Each of the OR gates 322, 324 and 326 corresponds to ones of the data signals DT1-DT6, . . . , which respectively represent a plurality of bits not adjacent to each other in the shift register 310, so as not to share the same data signal among the OR gates 322, 324 and 326. In this embodiment, since the number of the OR gates 322, 324 and 326, and the number of the delay elements 332, 334 and 336 are both three; each of the OR gates 322, 324 and 326 corresponds to one out of every three of the data signals DT1-DT6, . . . .

To be specific, the OR gate 322 corresponds to the data signals DT1, DT4, . . . , the OR gate 324 corresponds to the data signals DT2, DT5, . . . , and the OR gate 326 corresponds to the data signals DT3, DT6, . . . . The OR gate 322 performs an OR operation on the data signals DT1, DT4, . . . and outputs a result of the OR operation to the delay element 332 as a signal S1. The OR gate 324 performs an OR operation on the data signals DT2, DT5, . . . , and outputs a result of the OR operation to the delay element 334 as a signal S2. The OR gate 326 performs an OR operation on the data signals DT3, DT6, . . . and outputs a result of the OR operation to the delay element 336 as a signal S3.

The delay element 332 delays the signal S1, and outputs the delayed signal to the timing generators 341, 344, . . . as a signal DS1. The delay element 334 delays the signal S2, and outputs the delayed signal to the timing generators 342, 345, . . . as a signal DS2. The delay element 336 delays the signal S3, and outputs the delayed signal to the timing generators 343, 346, . . . as a signal DS3. The waveforms of the signals S1, S2, S3, DS1, DS2 and DS3 are as shown in FIG. 5.

The timing generators 341, 342, 343, 344, 345, 346, . . . correspond to the data signals DT1, DT2, DT3, DT4, DT5, DT6, . . . , respectively. The output circuits 361, 362, 363, 364, 365, 366, . . . correspond to the timing generators 341, 342, 343, 344, 345, 346, . . . respectively. The timing generator 341 generates a control signal CT1 including a pulse and a control signal CT2 including a pulse, and outputs the generated signals to the output circuit 361, in accordance with the corresponding data signal DT1 and the output of the delay element 332 corresponding to the data signal DT1.

Similarly, the timing generator 342 generates control signals CT3 and CT4, and outputs the generated signals to the corresponding output circuit 362, and the timing generator 343 generates control signals CT5 and CT6, and outputs the generated signals to the corresponding output circuit 363. The other timing generators 344-346, . . . operate similarly. As a result, the waveforms of the control signals CT1-CT6 and the output signals OUT1-OUT3 are as shown in FIG. 5.

According to the scan driver 300 shown in FIG. 4, since the delay element 332 for delaying the first, fourth, . . . data signals, the delay element 334 for delaying the second, fifth, . . . data signals, and the delay element 336 for delaying the third, sixth, . . . data signals are included, there is no need to include a delay element for each of the data signals. While two and three delay elements are used in the embodiments described above, a larger number of delay elements and corresponding OR gates may be included. When a number N (where N is an integer greater than or equal to two) of the delay elements are included, each of the delay elements may correspond to one out of every N number of the data signals DT1-DT6, . . . .

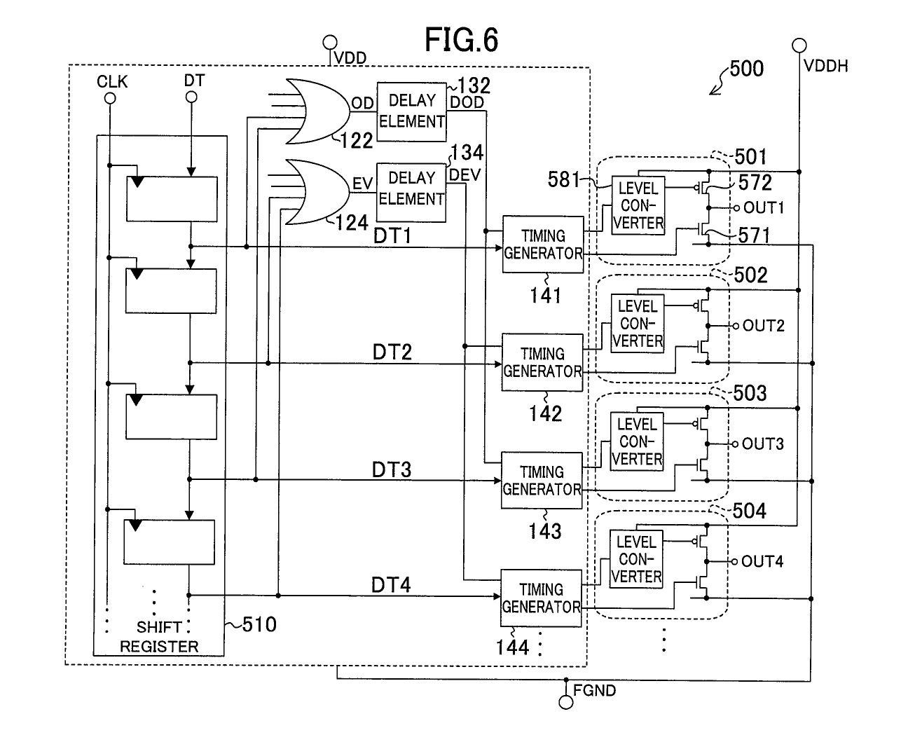

FIG. 6 is a block diagram illustrating the configuration of another modification of the scan driver shown in FIG. 2. Unlike the scan driver 100 of FIG. 2, a scan driver 500 of FIG. 6 includes output sections 501, 502, 503, 504, . . . instead of the output circuits 161-164. Otherwise, the scan driver 500 has a similar configuration to the scan driver 100 shown in FIG. 2. Furthermore, a power supply voltage VDD and the floating ground voltage FGND are supplied to a shift register 510, OR gates 122 and 124, delay elements 132 and 134, and timing generators 141-144, . . . ; and a power supply voltage VDDH and the floating ground voltage FGND are supplied to the output sections 501-504, . . . . The power supply voltage VDD is, for example, a voltage which is 5V higher than the floating ground voltage FGND.

When driving a plasma display panel as the display panel 194, a voltage much higher than the power supply voltage VDD for the circuits needs to be output as logic high levels of the output signals OUT1-OUT4, . . . . Therefore, the power supply voltage VDDH is supplied to a PMOS transistor 572 of the output section 501, and the scan driver 500 includes a level converter 581 to drive the PMOS transistor 572.

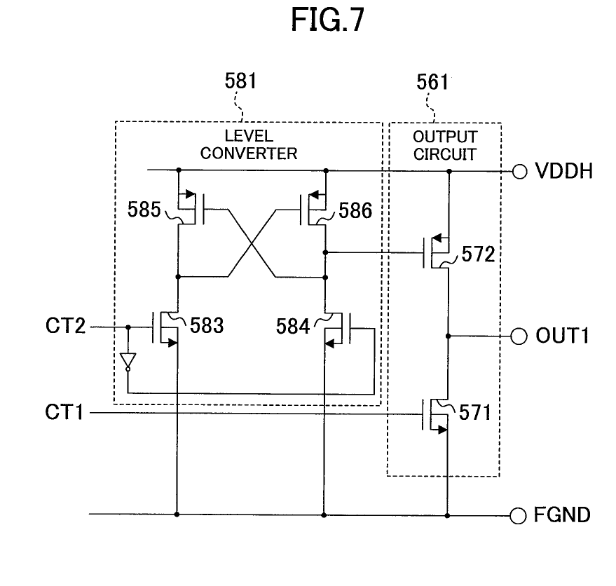

FIG. 7 is a circuit diagram illustrating an example configuration of the output section 501 shown in FIG. 6. The output section 501 includes an output circuit 561 and a level converter 581. The level converter 581 includes NMOS transistors 583 and 584, PMOS transistors 585 and 586, and an inverter. When the control signal CT2 is logic high, the NMOS transistor 583 and the PMOS transistor 586 are ON. Since the PMOS transistors 585 and 586 are coupled to a power supply for supplying the voltage VDDH, a voltage substantially equal to the voltage VDDH can be supplied to a gate of the PMOS transistor 572. This enables the PMOS transistor 572 to be turned OFF. That is, the level converter 581 converts and outputs the control signal CT2 so that a logic high level of the control signal CT2 is substantially equal to the voltage VDDH. Level converters of other output sections 502-504, . . . operate similarly.

The output circuits 161-164, 361-366 and the like include NMOS transistors and PMOS transistors as switching elements in the embodiments described above. Instead, elements capable of switching such as bipolar transistors and Insulated Gate Bipolar Transistors (IGBTs) may be used.

Other circuits and the like may be used instead of the OR gates 122, 124, 332, 334 and 336, as long as they can perform OR operations.

As shown in FIGS. 3 and 5, as long as two control signals can be generated so that a duration of a pulse of one of the control signals (e.g., the control signal CT2) includes a duration of a pulse of the other control signal (e.g., the control signal CT1), other circuits and the like may be used instead of the timing generators 141-144, 341-346, and the like.

The many features and advantages of the invention are apparent from the detailed specification and, thus, it is intended by the appended claims to cover all such features and advantages of the invention. Further, since numerous modifications and changes will readily occur to those skilled in the art, it is not desired to limit the invention to the exact configuration and operation illustrated and described, and accordingly all suitable modifications and equivalents may be resorted to, falling within the scope of the invention.

As described above, the present invention can reduce a circuit area, and is thus useful as a display driver and the like.

What is claimed is:

1. A display driver comprising:
a shift register configured to store bits represented by an input signal, and to serially shift the bits;
an OR circuit configured to perform an OR operation on a plurality of data signals respectively representing the bits in the shift register which are not adjacent to each other, and to output a result of the OR operation;
a delay circuit configured to delay the output of the OR circuit, and to output the delayed output;
a plurality of timing generators respectively corresponding to the data signals, where each of the timing generators generates and outputs a first control signal including a first pulse and a second control signal including a second pulse in accordance with a corresponding one of the data signals and the output of the delay circuit; and
a plurality of output circuits respectively corresponding to the timing generators, where each of the output circuits outputs a voltage of a first power supply in accordance with the first control signal of a corresponding one of the timing generators, and a voltage of a second power supply in accordance with the second control signal of the corresponding timing generator, wherein
a duration of the second pulse includes a duration of the first pulse.

2. The display driver of claim 1, wherein
each of the output circuits includes:
a first switching element coupled between the first power supply and an output node of the output circuit, and operating in accordance with the first control signal; and
a second switching element coupled between the second power supply and the output node, and operating in accordance with the second control signal.

3. The display driver of claim 1, further comprising a plurality of level converters respectively corresponding to the timing generators and converting the second control signal so that a logic high level of the second control signal is substantially equal to the voltage of the second power supply.

4. The display driver of claim 1, comprising multiple ones of the OR circuit and multiple ones of the delay circuit, wherein
each of the OR circuits corresponds to ones of the data signals, so as not to share a same one of the data signals with the other OR circuit(s),
the delay circuits respectively correspond to the OR circuits, delay the outputs of the corresponding OR circuits, and output the delayed outputs, and
each of the timing generators generates and outputs the first control signal and the second control signal in accordance with one of the data signals corresponding to the each of the timing generators and the output of one of the delay circuits corresponding to the one of the data signals.

5. The display driver of claim 4, wherein
the number of the delay circuits is N (where N is an integer greater than or equal to two), and
each of the delay circuits corresponds to one out of every N number of the data signals.

6. A display apparatus comprising:
a display panel; and
a display driver configured to generate a plurality of output signals to drive the display panel, wherein
the display driver includes:
a shift register configured to store bits represented by an input signal, and to serially shift the bits;
an OR circuit configured to perform an OR operation on a plurality of data signals respectively representing the bits in the shift register which are not adjacent to each other, and to output a result of the OR operation;
a delay circuit configured to delay the output of the OR circuit, and to output the delayed output;
a plurality of timing generators respectively corresponding to the data signals, where each of the timing generators generates and outputs a first control signal including a first pulse and a second control signal including a second pulse in accordance with a corresponding one of the data signals and the output of the delay circuit; and
a plurality of output circuits respectively corresponding to the timing generators, where each of the output circuits outputs a voltage of a first power supply in accordance with the first control signal of a corresponding one of the timing generators, and outputs a voltage of a second power supply in accordance with the second control signal of the corresponding timing generator, as a corresponding one of the output signals, wherein
a duration of the second pulse includes a duration of the first pulse.
